(19) United States
(12) Patent Application Publication
(10) Pub. No.: US 2014/0215837 A1
(43) Pub. Date: Aug. 7, 2014

(54) Cutter for adhesive and other tapes

(71) Applicant: Peter Stein, Azur (IL)

(72) Inventor: Peter Stein, Azur (IL)

(21) Appl. No.: 14/169,492

(22) Filed: Jan. 31, 2014

(30) Foreign Application Priority Data
Feb. 2, 2013 (GB) GB1301881.7

(51) Int. Cl. B26F 1/32

(52) U.S. Cl. CPC B26F 1/32
USPC 30/366

(57) ABSTRACT

Severing tools for adhesive and other tapes that are thin or are made from thin material and have one tip to allow their attachment to rolls of tape without substantially changing the outlook of the tape rolls and their production cost.

### SUMMARY OF THE INVENTION

This invention relates to tools to break and cut adhesive and non-adhesive tapes.

### BRIEF DESCRIPTION OF THE DRAWINGS

FIG. 1 is a side view of an adhesive or non-adhesive colorless and transparent tape rolled around a hollow core that has color and of an initial tape-start tag or sign placed between the first most outer layer of the tape roll and the second most outer layer of the tape roll.

FIG. 2 is a frontal view of a colorless and transparent, thin, axially bendable and resilient initial tape-start tag or sign that can be converted to a reusable sign and tape burster by properly bending it.

FIG. 3 is a frontal view of a mostly colorless and entirely or partially transparent initial tape-start tag or sign that carries an visible arrow pointing toward the proximal outer end of the tape and the end portion of the first most outer layer of the tape roll and carries visible lines indicating where to fold and/or axially bend the tag to convert it to a reusable tape-start sign, layer separator and/or tape burster.

FIG. 4 is a perspective view of the colorless and transparent tape roll of FIG. 1 with a initial tape-start tag of FIG. 3.

FIG. 5 is a perspective view of the prepared mostly colorless and transparent device that can be used as reusable tape-start sign, layer separator and tape burster.

FIG. 6 is a perspective view of a partially shown roll of tape with core and partially unrolled and bursted transparent tape that can have the core of the roll pulled over the third and/or forth finger of the right hand of the user while the thumb and one of the index and middle fingers of the right hand of the user press and hold the unrolled portion of the tape between the device and the thumb and hold the device between the tape and one of the index and middle fingers. The tape is stretched by the thumb between the roll and the thumb and between the thumb and the boundary of the free end of the tape held by being stuck to a surface or by other means while the two tape sections substantially diverge. A portion of the frontal side of the tape bursting device of FIG. 5 is shown through the tape and the orifice created by, and widened after, bursting the tape in a position that is substantially paralleling the tape section extending between the roll and the thumb.

FIG. 7 is the partial perspective view of the partially unrolled and bursted transparent tape of FIG. 6 which excludes the core and the rolled-up portion of the tape while the thumb and one of the index and middle fingers of the right hand of the user press and hold the tape between the device and the thumb and hold the device between the tape and one of the index and middle fingers while additionally the thumb, finger and bursting device are kept in contact with the tape.

FIG. 8 is a simplified side view of the partially shown roll of tape, kept in right hand, having an unrolled portion of tape kept between thumb and the bursting device and between thumb and one of the index and middle fingers while the bursting device is between tape and one of the index and middle fingers and the bursting tip of the device is shown bursting the tape. Only the tips of the thumb and of one of the index and middle fingers are shown.

FIG. 9 is a simplified side view of the partially shown roll of tape, kept in right hand, having an unrolled portion of tape pressed and kept between thumb and the bursting device and between thumb and one of the index and middle fingers while the bursting device is between tape and the index or middle finger while the thumb is shown breaking the tape. Only the tips of the thumb and finger are shown.

FIG. 10 is a frontal view of a partially or entirely transparent initial tape-start tag or sign that carries lines indicating where to fold the tag to convert it to a reusable tape-start sign and tape burster.

FIG. 11 is a simplified frontal view of the partially or entirely transparent device made by multiple folding from the piece shown in FIG. 10 that can be used as reusable tape-start sign and/or tape burster.

It is assumed in the drawings that the prepared device is going to be kept in and used by one's right hand involving especially the thumb, the index or first finger, and the middle or second finger. Left hand use is symmetrical. The prepared device in the description has at least one bursting tip, and its usage may involve adherence means or adhesive means like any combination of glue, wetness, humidity, micro suction cups, cohesion of surfaces, magnets and other means. The tape bursting device can be made, for instance, by folding or axially bending a piece cut off from a strip or sheet that can be flexible or can be axially bendable and resilient so that it can be curved along or parallel with the curve of the roll of tape and which, after being folded and/or axially bent, will substantially retain the partially or entirely folded and/or axially bent shape and have sufficient firmness.

This specification discloses embodiments for tape burster and breaker that can be unfolded, removable initial tape-start tag or sign ready to be reused as tag and/or tape burster or be converted to a reusable tape-start tag or sign and/or tape burster by folding and/or axially bending it along the lines that are printed, impressed, imprinted, etched, ingrained, made by heat treatment, made by bending, shown on adhesive label and/or provided on or attached by other means to the initial tape-start tag or sign and/or by folding it according to separately attached, printed and/or provided instructions. The device can be used for glue-less wide cellophane tapes also, for instance. These devices are simple and can be safe, light, easy to carry and inexpensive to manufacture, package, attach.

### DETAILED DESCRIPTION OF THE DRAWINGS

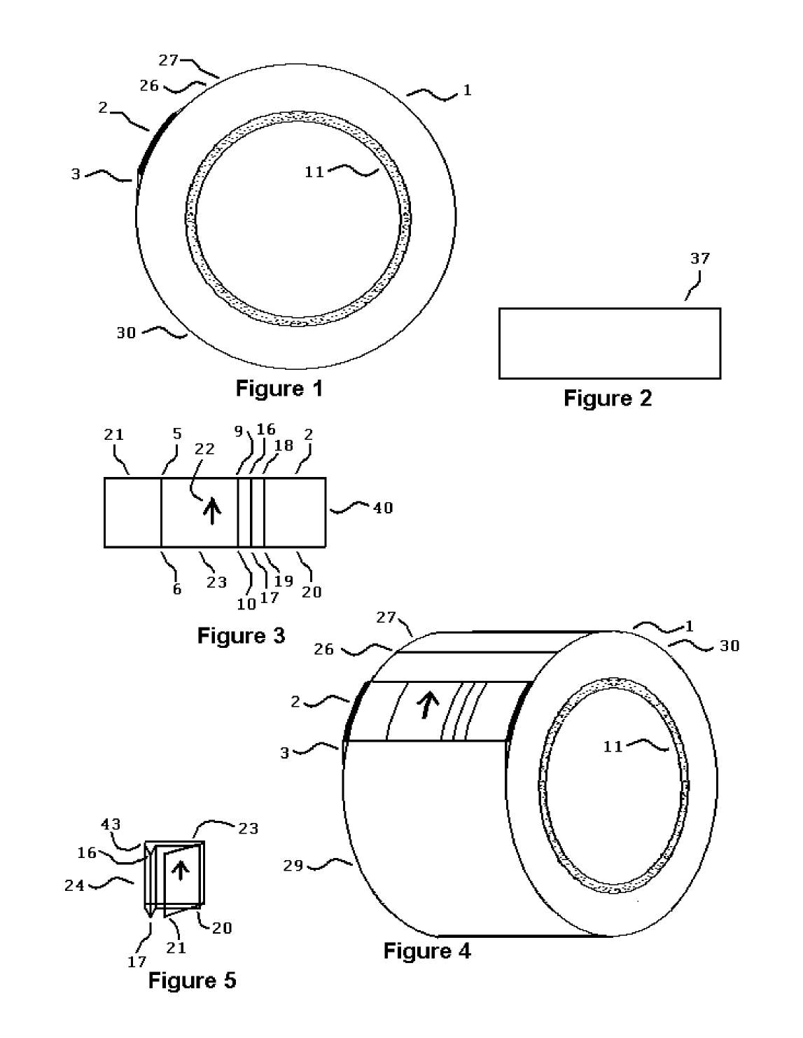

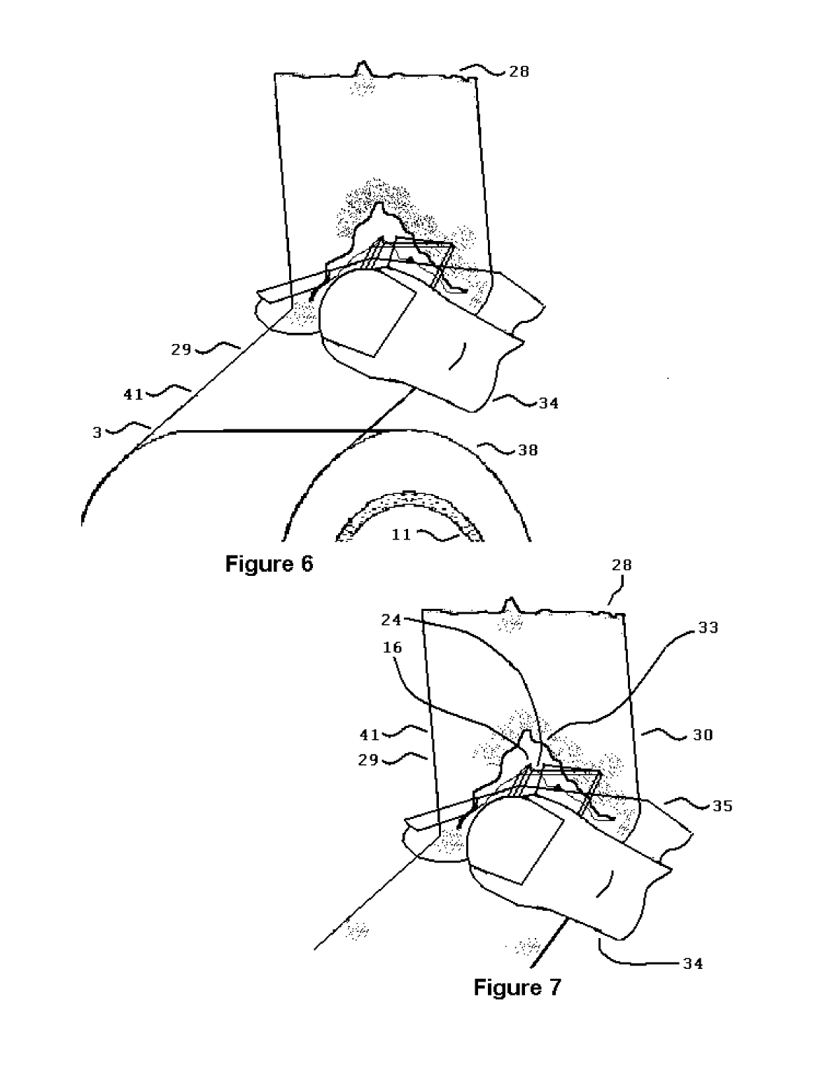

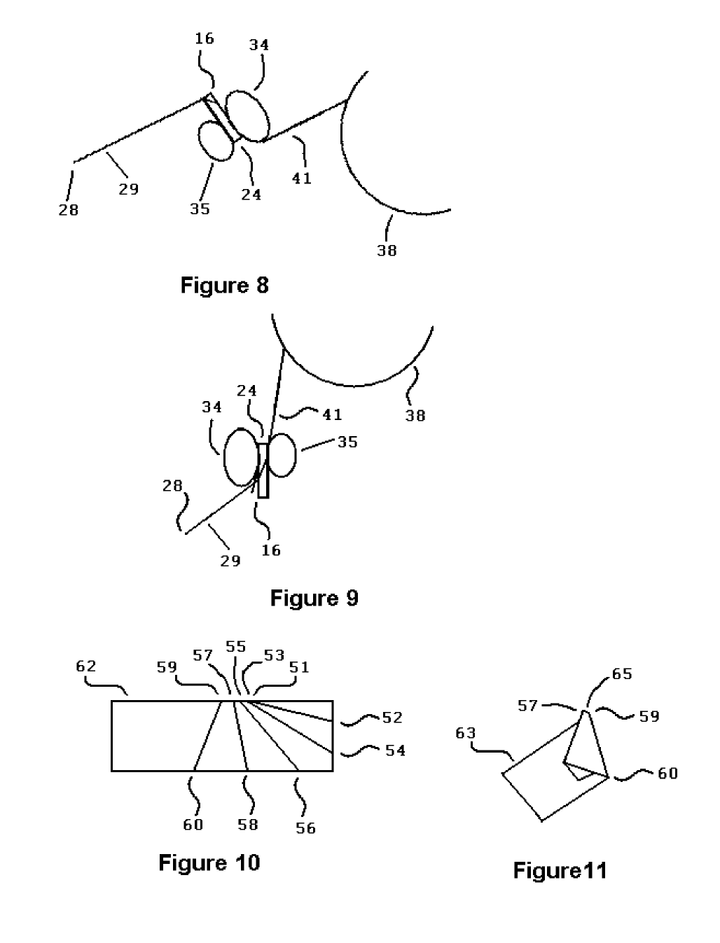

In the description the tape 1 in FIG. 1 and tape 38 in FIGS. 6, 8 and 9 can be adhesive tape or non-adhesive tape. If the tape 1 or 38 is not adhesive then the tape bursting device 24 in FIG. 5 and device 63 in FIG. 11 could have means to be reusably and removably adhered to the tape. The foldable and/or axially bendable piece of strip or sheet 2 in FIGS. 3 and 4, 37 in FIGS. 2 and 62 in FIG. 10 can be separated from the tape before it is folded and/or axially bent properly to provide a tape bursting and breaking device 24 in FIGS. 5, 6 and 7 or device 63 in FIG. 11 and the device can be reused as tape burster on both sides of an adhesive tape, and it may be used from an adhesive side of the tape by which the sticking of the device to the tape would necessarily precede the tape bursting and breaking action and thus could not be skipped, so sticking the device 24 and/or 63 to and bursting the tape with it can ensure a device that is adhered to the start of the tape 1 and/or 38 in FIGS. 6 and 8 and is easily findable on and separable from the tape 1 and/or 38.

In a new tape roll 1 the unfolded or non-assembled and flattened or flat device component 2, 37 and/or 62 could replace or follow a tag or sign of start of tape. In a roll of wide packaging tape 1 the device component 2, 37 and/or 62 could replace the initial tape-start tag or sign since it may have similar length and width but a greater thickness, which could be 0.4 mm for instance, if it is made from flexible or axially bendable and resilient strip or sheet like those used in blisters for packages. Such a device component piece would be flexible and could need no or minimal changes in the production process of tape rolls and it could be marked with lines indicating where to fold the piece of strip 2 and/or 62 to easily make a tape bursting and breaking device 24 and/or 63 respectively. The non-assembled source piece 2 of the device 24 and/or 62 of device 63 may also carry printed material and/or drawings like instructions, the arrow 22 in FIGS. 3 and 4 and/or images about the relative and proximal place of the start 26 of the tape 1 that is situated before the end portion 27 of the first most outer layer of the tape roll 1 in the indicated direction. Directions for use could be printed on the inside of or on the hollow core 11 around which the tape of roll 1 is rolled up.

In a roll of tape 1 the flexible and/or axially bendable and resilient piece 2, 37 and/or 62, that is convertible to tape burster 24 and/or 63 which may be also a reusable tape-start sign, could be longer and lay under a longer length of tape section when the tape is narrow or the design and usage purpose of the tape burster would need a source piece having a larger area that may carry marks and info and could be partially cut to be bent and/or folded by following the instructions.

To fold a flat piece of sheet 2 in FIG. 3 to convert it to a device 24 that can burst the tape 1 and/or 38 and which may be used also as sign of start of tape 1 and/or 38 when the tape has at least one side covered, at least partially, by adhesive means and/or the assembled device 24 has a side or the side with the bursting tip 16 covered by adhesive means that may be reusable, the two adjacent areas delimited by the three subsequent line segments—extending between their extreme points 9 and 10, 16 and 17, 18 and 19 respectively—have to be axially bent along the middle line segment between extremes 16 and 17 so that they form a shape having a narrow-enough V-form profile or a triangle with a missing base opposite to tip 16 in FIG. 5 and so the two subsequent portions of the piece form a narrow hollow wedge having a relatively long edge extending between extremes 16 and 17 in FIG. 5. By axially bending the piece 2 in FIG. 3 along the lines extending between their extreme points 5 and 6, 9 and 10, 16 and 17, 18 and 19 as shown in FIG. 5 the hollow V-profile wedge shape formed by the two portions on the two sides of the edge between extremes 16 and 17 will practically become a construction that is stable and firm enough during its holding in hand and usage for tape bursting and breaking. The piece 2 will be axially bent along the leftmost line between extremes 5 and 6 and the leftmost portion 21 will be axially bent over the rightmost boundary 40 of the piece 2 to keep the construction stable and firm. By axially bending the piece along the two leftmost lines between extremes 5 and 6, 9 and 10 as shown in FIG. 5 the portion 23 delimited by the two leftmost bars between 5 and 6, 9 and 10 in FIG. 3 will lay parallel and will double the rightmost portion 20 of the piece 2 while the two strips adjacent to edge between extremes 16 and 17 of the “V”-profile shape stay practically equally steeply tilted relative to and protruding from the board 43 of the portions 23 and 20 of the device 24.

When device 24 is used as a tape burster and before the unrolled tape 41 is bursted and partially broken as shown in FIGS. 6 and 7 and in simplified side view of FIG. 9, the device 24 in FIG. 5 can be held pressed to the back side of the unrolled transparent tape 41 in FIG. 7 extending between its boundaries 29 and 30 while tape 41 and device 24 are kept between the thumb 34 and ne of the second and first fingers 35 in such a position that the edge line between extremes 16 and 17 on top of the protruding “V” profile construction touches the back side of the stretched tape 41 and is parallel to or slightly tilted relative to the boundary lines 29 and 30 and is at sufficient distance or at roughly equal distance from the boundaries 29 and 30. Right before bursting the tape 41 it happens that the tape 41, device 24, edge between extremes 16 and 17, and/or portion 20 and/or portion 21 are pressed together in between the thumb 34 and the second or first finger 35 of the right hand of the user, and these two fingers 34 and 35 are placed at distance from the protruding tape-bursting corner and/or tip 16 of the device 24, and the thumb 34 placed on and pressing the portion of tape 41 that is on the axial bending edge between extremes 16 and 17 and/or thumb 34 is on the larger axially bent area 21 of the device 24 and the second or first finger 35 is placed on the back side 23 and pressing the device 24 on the base of the “V”-profile construction opposite to its axial bending line between extremes 16 and 17. If at least one side of the tape 41 is having adhesive means then the device 24 can be placed and stuck to the tape 41 before starting the bursting and breaking of the tape 41. Thereafter the tape 41 can be stretched and the tape 41 and/or the device 24 can be rotated so that the upper protruding corner or tip 16 of the device 24 can be preferably briskly pulled against the adhesive back side of the stretched tape 41 to collide with the tip 16 when the thumb 34 and finger 35 so hold the edge between extremes 16 and 17 that it is totally or almost included in a plane that is simultaneously perpendicular to the surface of the stretched tape 41, and to the portion of back side 23 that is not behind portion 20 of the device 24 in FIGS. 5, 6, 7 and parallel to tape boundaries 29 and 30. Such a collision can burst the tape 41 at the contact point with tip 16 in FIG. 8 along a widening short line 33 in FIG. 7.

After the device 24 and the upper tip 16 of its construction having the “V” profile burst the tape 41 the device 24 and the portion of the tape 41 that is kept between the fingers 34 and 35 can be aligned to substantially parallel or be in the same plane as the tape portion 41 that is stretched between the thumb and tape end 28 and to be in its continuation before being pulled by fingers 34 and 35 to completely break the tape 41, or alternatively to be pushed by the thumb 34 to stretch the tape 41 and be managed to rotate relative to the tape 41 in a direction that is a contrary direction to the relative rotation made right before and during the bursting of the tape 41 until the edge between extremes 16 and 17 and portion 20 are facing toward the unrolled and free end 28 of the tape 41 and/or 26 of tape 1 after being unrolled ensuring the relatively most unimpeded peeling and breaking of the tape 41 off a part of the frontal surface including portion 21 of device 24 and off the finger 35. In the latter cases, by pulling the tape with thumb 34 and finger 35 and/or by pushing the tape 41 that is between the thumb 34 and the device 24 with the thumb 34 to stretch the portion of the tape 41 that extends between tape end 28 and the device 24, the tape 41 can be broken along a line that completes line 33 and is running across the tape roughly perpendicularly to both boundary lines 29 and 30 like the previous break line 28. The break line, that is created by continuing and completing the line 33, runs on device 24 and through or slightly under the bursting corner or tip 16 and under the upper boundary of the board 43 of the device 24. If the side of the tape 41 facing device 24 and tip 16 carries adhesive means and/or there is adhesive means between the two then the device 24 will stay stuck on that side after the tape 41 is broken and the break line will run roughly along the portions of the holding second or first finger 35 that touched the tape and slightly under the bursting corner or tip 16 of the device and under the upper boundary of board 43.

Using this kind of tape bursting and breaking devices and methods more kinds of tapes and adhesive tapes can be bursted and broken and could come with an inexpensive tape start sign that can be removed and converted to a reusable tape start sign and/or tape burster and breaker. When using this device 24 the breaking of the tape 41 may occur automatically after the bursting of the tape or by firmly keeping the tape 41 and pressing it to the device 24 while both are held between the thumb 34 and finger 35 and stretching the tape portion extending between the device 24 and the free end 28 of the unrolled tape portion 41 while the thumb 34 is pushing the tape 41 and the device 24 so that the tape is partly peeled off the device 24 and the holding finger 35 while the incomplete break line grows until the tape 41 is broken.

Some tapes may need a sturdier bursting device 63 like the one shown in FIG. 11 that is more suitable for easy reuse than a round conical shape having no folding lines and would unwind when not held tightly in hand and squeezed. The device 63 is made by multiple, spiraling and consecutive folding of the piece 62 shown in FIG. 10 along the lines extending between the extremes 51 and 52, 53 and 54, 55 and 56, 57 and 58, 59 and 60 in this order and in a unchanging rolling direction by ensuring that each folding is landing onto the frontal side of the subsequent portion of piece 62 and/or according to a separate instruction set. The device 63 in FIG. 11 is to be used like the device 24 shown in FIG. 5 with the second or first finger extending between the tape boundaries and behind the device while pressing it to the tape and the thumb and substantially contacting the tape, so that when the tip 65 starts bursting the tape it is touching the tape length that extends between the pressing finger and the free end of the tape and preferably the tape so touches and faces the device 63 that if the face of the tape carries adhesive means the stuck device 63 will keep the rolled-up form.

As part of the production process, a wide enough sheet roll around long cylinder core can be printed or get adhered to marks and info and be cut in strips parallel to the length of the core. Alternatively, a sheet roll around a long cylindrical core can get impressed, printed, adhered to marks and/or info and/or other sign means and can be cut in tape rolls having disc-like shapes and narrow profiles that would get unrolled and flattened by counter rolling and for by other means like heat treatment to enable a production sequence that is similar to those currently used for attaching initial tape-start and/or tape-separator tags or signs to tapes.

When the tape burster is also used as reusable tape-start sign which is stuck to the side and location of the tape where the tip 16 and/or 65 of the device got in touch with the tape, before it bursted the tape and stayed there after the tape was broken, the tape burster can be easily removed by folding the tape portion stuck to the tape bursting device backward such that it will be between the device and the other tape wing along the folding line and thus the burster tip and/or its vicinity can be pushed parallel to the folded and overlaying portions of the tape by which the tape gets peeled off the device and it can be held between the middle and index finger until it will be stuck to the tape and possibly reused for bursting and breaking the tape and/or as tape-start tag or sign.

Axially bending along any line on the source piece 2 can be easily started and/or done by placing the piece 2 on a dense and unrolled part of the most outer layer of the tape roll 1 and practically laying the line on piece 2 on one of and part of piece 2 between the two boundaries 29 and 30 before firmly pressing the part of piece 2 to the outer layer between boundaries 29 and 30 and perpendicularly pushing the outlying portion in the vicinity of and/or right in the center of the line on piece 2 toward the center of the circle in the nearest round end of the cylinder of core 11 and/or roll 1. The roll 1 can be used similarly for source piece 62.

The transparent and plain source piece 37 in FIG. 2 can indicate the exact or proximal location of the tape start by making the roll 1 to be protuberant where it lies above and/or under the most outer layer of the tape roll 1, and/or can be converted to tape burster with bare hands through the following steps: bending the piece 37 and align its ends then folding it in two to make a bending line in the middle of and perpendicular to the longer boundaries, axially bending again the folded piece parallel to and along a new line 2 to 4 mm far from the first bending line to form two overlaying and almost equal strips, forming a V-profile wedge with the two strips on two sides of the first bending line and aligning all bending lines and free shorter boundaries to be practically parallel, holding and pressing the remaining layers against each other, to keep the wedge shape unchanged, and axially bending them together, toward the side having the wedge, along a line that is 2 to 4 mm far from and parallel to the free shorter boundary on the opposite side. Before or after the first bending line on the plain and transparent piece 37 is made, the tape roll 1 can be used for parallel alignments and for starting and/or making practically straight bending lines in ways resembling the way described for piece 2. Roll 1 can be used also for axial bending along the lines of source piece 62.

Other embodiments of the invention, like a sturdy triangle having practically a straight line or curved line profile, can provide ready made reusable tags and/or tape bursters.

This kind of devices, unlike many dispensers, don't request that roll 1 and/or 38 to be round rolls and they could have other shapes like one having a narrow and/or flat rectangular profile for easy storing and carrying for instance.

1. A tool for separating a tape, said tape having two sides and two border lines and two end borders, said tape having a first end and a closing second end, said tool having a tip, said tip having a top, at least said top of tip serving for being pressed to a side of said tape to make a piercing through said tape, said piercing making an opening on said tape, said opening allowing a severing of said tape by enlarging said opening on said tape by a stretching of said tape;
said severing of said tape creating a first part of said tape and a second part of said tape, said second part of said tape having a second first end;
and said tool being a member of a group consisting of an object serving for said severing the tape, an object serving for said severing of said tape and for indicating a place of said second first end of said second part of said tape, and an object serving for said severing of said tape and for indicating said place of said second first end of said second part of said tape.

2. Said tool for separating said tape of claim 1 wherein said tool and at least a side of said tape being able to adhere to and to separate from each other;
whereby in use at least said top of said tip of the tool being pressed against the side of said tape, said pressing making said piercing of and said opening on said tape, at least a part of said tool being adhered to a place on said side of said tape, said stretching of said tape causing said severing of said tape,
said severing of said tape leaving said tool and said tape adhered to each other at least at a part of said place and at said second first end of said second part of the tape, and said second part of said tape extending in essence between said top of said tip and said closing second end of said tape.

3. Said tool for separating said tape of claim 1 wherein said tool comprising at least a piece, said piece is having a side view that is in essence a member of the group consisting of a line and a curved line;
said piece being a member of the group consisting of an object being said piece, an object being practically at least partially flexible, an object being practically at least partially rigid at least when in use, an object being at least partially resilient, an object having in essence said tip, an object being said piece having a side view of said line, and a sheet; and
said tool being a member of the group consisting of an object having said tip, an object having said tip and being said piece, an object being made from said piece by forming at least part of said piece into said tip and having said tip being enforced from its inside by bent layers of at least part of said piece, an object being made from said piece by forming at least part of said piece into said tip and having said tip being enforced from its inside by axially bent layers of at least part of said piece, an object made from said piece by axially bending said piece at least once, an object made from said piece by axially bending said piece along at least three bending lines, an object being made from said piece by axially bending said piece at least twice and having at least in use in essence a profile including a hollow triangle, an object being made from said piece by axially bending said piece at least twice and having at least in use in essence a profile including said hollow triangle having said top of said tip one of its vertexes,
an object being made from said piece by axially bending said piece at least twice and having at least in use said top of tip being in essence at invariable distance from a plane including part of said piece,
an object being made from said piece by axially bending said piece at least twice and having at least in use said top of tip being in essence at invariable distance from a plane including part of said piece and said tip having in essence an external surface and no inside,
an object being made from said sheet by axially bending said piece at least twice and having at least in use said top of tip being in essence at invariable distance from a plane including part of said piece and said tip having in essence an external surface and no inside,
an object being made from said sheet by forming at least part of said sheet into said tip and said tip being enforced from its inside by bent layers of at least part of said sheet, an object being made from said sheet by forming at least part of said sheet into said tip being enforced from its inside by axially bent layers of at least part of said sheet, an object made from said sheet by axially bending said sheet at least once, an object made from said sheet by axially bending said sheet along at least three bending lines and said sheet having a rectangular shape and said sheet having four border lines and said bending lines being parallel to two border lines of said sheet and said three bending lines being parallel to each other, an object being made from said sheet by axially bending said piece at least twice and having at least in use in essence a profile including said hollow triangle, an object being made from said sheet by axially bending said sheet at least twice and having at least in use said top of tip being in essence at invariable distance from a plane including a part of said sheet,
an object being made from said sheet by axially bending said piece at least twice and having at least in use in essence a profile including a hollow triangle, an object being made from said sheet by axially bending said piece at least twice and having at least in use in essence a profile including said hollow triangle having said top of said tip one of its vertexes, and
an object being made from said sheet by axially bending said sheet at least twice and having at least in use said top of tip being in essence at invariable distance from a plane including a part of said sheet.

4. Said tool for separating said tape of claim 2 wherein said tool comprising at least a piece, and said piece is having a side view that is in essence a member of the group consisting of a line and a curved line;
said piece being a member of the group consisting of an object being said piece, an object being practically at least partially flexible, an object being practically at least partially rigid at least when in use, an object being at least partially resilient, an object having in essence said tip, an object being said piece having a side view of said line, and a sheet; and
said tool being a member of the group consisting of an object having said tip, an object having said tip and being said piece,
an object being made from said piece by forming at least part of said piece into said tip and having said tip being enforced from its inside by bent layers of at least part of said piece, an object being made from said piece by forming at least part of said piece into said tip and having said tip being enforced from its inside by axially bent layers of at least part of said piece, an object made from said piece by axially bending said piece at least once, an object made from said piece by axially bending said piece along at least three bending lines,
an object being made from said piece by axially bending said piece at least twice and having at least in use in essence a profile including a hollow triangle, an object being made from said piece by axially bending said piece at least twice and having at least in use in essence a profile including said hollow triangle having a vertex being said top of said tip,
an object being made from said piece by axially bending said piece at least twice and having at least in use said tip being in essence at invariable distance from a plane including part of said piece,
an object being made from said piece by axially bending said piece at least twice and having at least in use said top of tip being in essence at invariable distance from a plane including part of said piece and said tip having in essence an external surface and no inside,
an object being made from said sheet by axially bending said piece at least twice and having at least in use said top of tip being in essence at invariable distance from a plane including part of said piece and said tip having in essence an external surface and no inside,
an object being made from said sheet by forming at least part of said sheet into said tip and said tip being enforced from its inside by bent layers of at least part of said sheet, an object being made from said sheet by forming at least part of said sheet into said tip being enforced from its inside by axially bent layers of at least part of said sheet, an object made from said sheet by axially bending said sheet at least once, an object made from said sheet by axially bending said sheet along at least three bending lines and said sheet having a rectangular shape and said sheet having four border lines and said bending lines being parallel to two border lines of said sheet and said three bending lines being parallel to each other, an object being made from said sheet by axially bending said piece at least twice and having at least in use in essence a profile including said hollow triangle, an object being made from said sheet by axially bending said sheet at least twice and having at least in use said tip being in essence at invariable distance from a plane including a part of said sheet,
an object being made from said sheet by axially bending said piece at least twice and having at least in use in essence a profile including said hollow triangle, an object being made from said sheet by axially bending said piece at least twice and having at least in use in essence a profile including said hollow triangle having said vertex being said top of said tip, and
an object being made from said sheet by axially bending said sheet at least twice and having at least in use said tip being in essence at invariable distance from a plane including a part of said sheet.

5. Said tool for separating said tape of claim 1 wherein said tool being at least a piece, said piece is having a side view that is in essence a member of the group consisting of a line and a curved line;
said piece being a member of the group consisting of an object being said piece, an object having in essence at least part of said tip, an object being practically at least partially flexible, an object being practically at least partially rigid at least when kept in hand and in use, an object being practically at least partially firm and an object being practically at least partially resilient.

6. Said tool for separating said tape of claim 2 wherein said tool being at least a piece, said piece is having a side view that is a member of said group consisting of a line and a curved line;
said piece being a member of the group consisting of an object being said piece, an object having in essence at least part of said tip, an object being practically at least partially flexible, an object being practically at least partially rigid at least when kept in hand and in use, an object being practically at least partially firm at least when kept in hand and in use, and an object being practically at least partially resilient.

7. Said tool for separating said tape of claim 3 wherein
said top of said tip being in essence said vertex of said triangle, at least in use said triangle being in essence the periphery of a base of a hollow triangular prism, at least in use said prism having three rectangular faces and three parallel edges, said three parallel edges of said prism being subsequent bending lines of said sheet;
said sheet is divided in two imaginary subsheets by a common bending line, said common bending line extending between two ends, said top of said tip is an end of said common bending line, a rectangular face of said prism excluding said top of said tip and is opposite to said top of said tip and to said common bending line;
said sheet having at least two imaginary remaining parts being not included in said triangular prism, at least in use said remaining parts ensuring the stability of said prism,
said sheet having a first imaginary remaining part and a second imaginary remaining part, said sheet having a first end and a second end, said two ends of said sheet being said border lines of said sheet paralleling said bending lines,
said first end of said sheet being said end of said first remaining part of said sheet, said second end of said sheet being said end of said second remaining part of said sheet,
said first remaining part of said sheet having a fourth bending line paralleling said ends of said sheet and being axially bent along said fourth bending line,
said end of said second remaining part and said fourth bending line in essence paralleling and overlaying each other, said first remaining part of said sheet is being bent around said end of said second remaining part of said sheet,
said end of said first remaining part and said top of tip being not separated by a imaginary plane including said face of said prism opposite said top of tip,
said end of said second remaining part is being inserted between an end portion of said first remaining part of sheet and said plane, and said top of tip being farther from said fourth bending line than said end of said first remaining part of sheet;
whereby in use said second part of tape being at least partially rolled to form a new roll, said second first end of said second part of tape being on a continuation part of the convex outer surface of said roll of said second part of tape, said tool simultaneously serving as a reusable tab, said tab indicating place of said second first end of said second part of tape,
at least a side of said second part of tape being adhesive, said adhesive side of said second part of tape being on the concave side of said roll of said second part of tape,
said tool being adhered to said adhesive side of said second part of tape, and said tab separating at least partially between said second first end of said second part of tape and a convex surface of an inner layer of said roll of said second part of tape.

8. Said tool for separating said tape of claim 4 wherein
said top of tip being in essence said vertex of said triangle, at least in use said triangle being in essence the periphery of a base of a hollow triangular prism, at least in use said prism having three rectangular faces and three parallel edges, said three parallel edges of said prism bending subsequent bending lines of said sheet;
said sheet being divided in two imaginary subsheets by a common bending line, said common bending line extending between two ends,
said top of tip is an end of said common bending line, a rectangular face of said prism excluding said top of tip and being opposite to said top of tip and to said common bending line;
said sheet having at least two imaginary remaining parts being not included in said triangular prism, at least in use said remaining parts ensuring the stability of said prism,
said sheet having a first imaginary remaining part and a second imaginary remaining part, said sheet having a first end and a second end, said two ends of said sheet being said border lines of said sheet paralleling said bending lines,
said first end of said sheet being said end of said first remaining part of sheet, said second end of said sheet being said end of said second remaining part of sheet,
said first remaining part of said sheet having a fourth bending line paralleling said ends of said sheet and being axially bent along said fourth bending line,
said end of said second remaining part of sheet and said fourth bending line in essence paralleling and overlaying each other, said first remaining part of said sheet is being bent around said end of said second remaining part of sheet,
said end of said first remaining part and said top of tip being not separated by a imaginary plane including said face of said prism opposite said top of tip, said end of said second remaining part is being inserted between an end portion of said first remaining part of sheet and said plane, and said top of tip being farther from said fourth bending line than said end of said first remaining part of sheet;
whereby in use
said second part of said tape being at least partially rolled and form a new roll, said second first end of said second part of tape being on a continuation part of the convex outer surface of said roll of said second part of said tape, said tool simultaneously serving as a reusable tab, said reusable tab indicating the place of said second first end of said second part of tape,
at least a side of said second part of tape being adhesive, said adhesive side of said second part of tape being on the concave side of said roll of said second part of tape,
said tool being adhered to said adhesive side of said second part of tape, and said tab separating at least partially between said second first end of said second part of tape and a convex surface of an inner layer of said roll of said second part of tape.

9. A convertible combination comprising a length of tape and a usage agent, said length of tape and usage agent being at least indirectly connected,
said length of tape substantially forming a roll of tape, said combination and said roll of tape being in an initial state, said initial state being the state of said combination at the end of manufacturing of said combination and before a modification of said combination being made by a user, said roll having an imaginary axis line, said tape forming said roll having a first side and a second side, said second side of said tape facing said axis, said length of tape extending between a start end and a second end, said second end of said tape being closer to said axis of said roll than said start end;
said combination having substantially identical exterior side views, said side views of said combination being parallel to said axis of said roll, said side views of said combination being substantially identical to all exterior profiles of said initial roll that are parallel to said axis and to all exterior profiles parallel to said axis of a shape obtained by removing at least said usage agent from said initial combination;
said initial combination being convertible to a second combination through a process including at least three steps, said steps being chronologically ordered;
the first of said steps being a converting of said initial usage agent into a reusable severing tool by at least a removing said initial usage agent from said combination;
the second of said steps being a beginning of additionally converting said tool to a reusable tape-start tag by sticking said tool to a spot on said second side of an unrolled portion of said initial tape;
the third of said steps being a removal of a part of said unrolled portion and a finishing of said conversion to said second combination, said part of said unrolled portion extending in essence between said start of said initial tape and a part of said tool, said removal of said part of said unrolled portion being done by a severing said unrolled portion of said tape with said tool, said tool staying stuck to said spot during said severing, said severing making a removed tape and a remaining tape, said remaining tape having a new start end and said second end of said tape, a part of said initial roll of tape being a remaining roll formed by at least part of said remaining tape; said tool additionally serving as said reusable tape-start tag by staying at least partially stuck to at least part of said spot and to said new start end of said remaining tape, said tool separating at least partially between said start of said remaining tape and a convex surface of an immediately inner layer of said remaining roll of tape;
said initial usage agent is a member of the group consisting of an object being convertible into said reusable severing tool, an object being an initial tape-start tag indicating said place of said start end of said tape, and an object being convertible into said reusable severing tool;
said severing tool is a member of the group consisting of an object being said tool for separating said tape, an object being said tool for separating said tape and having a tip having a top, an object being convertible into a used usage agent having substantially the same shape as said usage agent, and an object being said tool and being convertible into said used usage agent by unfolding said tool;
said top of said tip serving for being pressed to a side of said tape to make a piercing through said tape and an opening on said tape allowing said severing of said tape by enlarging said opening on said tape by a stretching of said tape;
said initial combination is a member of the group consisting of an object being said initial combination, and an object having a shape and dimensions substantially the same as the shape and dimensions of said initial roll and of a shape obtained by removing at least said usage agent from said initial combination;
said initial usage agent is a member of the group consisting of an object being convertible into said reusable severing tool, an object having a side view that is in essence a line, an object having a side view that is in essence said line and having said tip, an object having a side view that is in essence a curved line and having said tip, an object having a side view that is in essence a curved line,
an object being practically at least partially flexible, an object being practically at least partially rigid while being kept in hand and in use, and an object being practically at least partially resilient,
and an object being at least partially a sheet;
said severing tool is a member of the group consisting of an object being said severing tool, an object made by axially bending said initial usage agent at least once, object having said tip made by axially bending said initial usage agent at least once,
an object being said initial usage agent having a side view that is in essence said line, an object being said initial usage agent having a side view that is in essence said line and having said tip, an object being said initial usage agent having a side view that is in essence said curved line and having said tip,
an object being made from said usage agent by axially bending said usage agent at least twice and at least in use having in essence a profile including a hollow triangle, an object being made from said usage agent by axially bending said usage agent at least twice and at least in use having in essence a profile including said hollow triangle having a vertex being said top of said tip,
an object being made from said usage agent by axially bending the usage agent at least twice and at least in use having said top of tip being in essence at invariable distance from a plane including a part of said usage agent,
an object being made from said usage agent by axially bending said usage agent at least twice and having at least in use said top of tip being in essence at invariable distance from a plane including part of said piece and said tip having in essence an external surface and no inside,
an object having said tip made by axially bending said initial usage agent at least once, an object having said tip made from said initial usage agent by forming at least part of said initial usage agent into said tip and having said tip being enforced from its inside by bent layers of at least part of said initial usage agent, an object having said tip made from said initial usage agent by forming at least part of said initial usage agent into said tip and said tip being enforced from its inside by axially bent layers of at least part of said initial usage agent, an object made from said initial usage agent by axially bending said initial usage agent at least once, an object having said tip made from said initial usage agent by axially bending said initial usage agent at least once, an object having said tip made from said initial usage agent by axially bending said initial usage agent along at least three bending lines and having said initial usage agent having a rectangular shape and four border lines and said bending lines being parallel to two border lines of said initial usage agent and said three bending lines being parallel to each other, an object made from said initial usage agent by axially bending said initial usage agent along at least three bending lines and having said initial usage agent having a rectangular shape and four border lines and said bending lines being parallel to two border lines of said usage agent and said three bending lines being parallel to each other,
an object having said tip made by axially bending said sheet at least once, an object having said tip made from said sheet by forming at least part of said sheet into said tip and having said tip being enforced from its inside by bent layers of at least part of said sheet, an object having said tip made from said sheet by forming at least part of said sheet into said tip and said tip being enforced from its inside by axially bent layers of at least part of said sheet,
an object being made from said sheet by axially bending said piece at least twice and having at least in use said top of tip being in essence at invariable distance from said plane including part of said piece and said tip having in essence an external surface and no inside,
an object made from said sheet by axially bending said sheet at least once, an object having said tip made from said sheet by axially bending said sheet along at least three bending lines and having said sheet having a rectangular shape and four border lines and said bending lines being parallel to two border lines of said sheet and said three bending lines being parallel to each other, and an object made from said sheet by axially bending said sheet along at least three bending lines and having said sheet having a rectangular shape and four border lines and said bending lines being parallel to two border lines of said sheet and said three bending lines being parallel to each other;
said plane in essence being a member of a group consisting of an object being imaginary and having in essence two dimensions and including said part of said usage agent having a side view being said line, and an object being imaginary and having in essence two dimensions and including said part of said usage agent having a side view being said curved line;
and said tape is a member of the group consisting of an object being said tape, and an object being said tape and having said severing tool and at least one of said sides of said tape being able to adhere to and to separate from each other, and an object having at least a side of said tape being an adhesive side and said adhesive side of said tape being on the concave side of said roll of tape and said adhesive side facing said axis.

10. Said convertible combination of claim 9 wherein
said second combination being convertible to a third combination of said tool and a length of tape through a second process including at least four chronologically ordered steps, said remaining roll of said second combination being a second roll;
a first step of said second process being a simultaneous holding of said second combination in a hand of a user and said removing of said tool from said tape of said second combination, and said holding hand having a thumb and a first finger and second finger;
a second step of said second process being a simultaneous holding of said second roll of tape in said holding hand, and a holding of said tool between said first finger and said second finger and an unrolling of a portion of said remaining tape;
a third step of said second process being a simultaneous holding of said second roll of tape in said holding hand, a holding of said tool between said first and said second finger, and an adhering of said tool to said unrolled portion of said remaining tape of said second combination using said first finger and said second finger;
and a fourth step of said second process being a simultaneous holding of said second roll of tape and of said adhered tool to said second roll in said holding hand, a keeping of said tool and a part of said second unrolled portion of said remaining tape between said second finger and said thumb, and a severing of said unrolled portion of said remaining tape by at least pressing said tool to said part of said unrolled portion of said remaining tape using said thumb and said second finger.

11. Said convertible combination of claim 10 wherein said tool being made by axially bending said piece along at least three bending lines;
said sheet having a rectangular shape, said sheet having four border lines, said bending lines being parallel to two border lines of said sheet and to each other, said tool having said tip, said tip having a top, said top of tip serving for being pressed to a side of said tape to make a piercing through said tape and for severing said tape, and said top of said tip being an end of an axial bending line.

12. Said convertible combination of claim 11 wherein in use said tip being in essence a triangle, at least in use said triangle being in essence the periphery of a base of a hollow triangular prism, at least in use said prism having three rectangular faces, all three parallel edges of said prism are three subsequent bending lines of said sheet,
said sheet is divided in two imaginary subsheets by a common bending line including said top of said tip,
one of said faces of said prism not including said top of said tip, and said face is opposite to said top of said tip and to said common bending line.

13. Said convertible combination of claim 12 wherein
said sheet having at least a two imaginary remaining parts being not included in said triangular prism, and at least in use said remaining parts of said sheet ensuring the stability of said prism.

14. Said convertible combination of claim 13 wherein
said sheet having a first imaginary remaining part and a second imaginary remaining part, a two border lines of said sheet paralleling said bending lines being two ends of said sheet, an end of said first remaining part of said sheet being one of said ends of said sheet, an end of said second remaining part of said sheet being one other of said ends of said sheet, and said remaining parts of said sheet having distinct ends,
said first remaining part of said sheet having a fourth bending line parallel to said ends of said sheet and being axially bent along said fourth bending line,
said end of said second remaining part of sheet extending to and paralleling and in essence overlaying said fourth bending line, said first remaining part of sheet being bent around said end of said second remaining part of sheet,
said end of said first remaining part of sheet and said top of said tip being not separated by said imaginary plane including said face of said prism opposite said top of said tip, said end of said second remaining part of said sheet being inserted between an end portion of said first remaining part of sheet and said plane, and said top of said tip being farther from said fourth bending line than said end of said first remaining part of said sheet.

15. Said convertible combination of claim 14 wherein said remaining tape being at least partially rolled forming said second roll, said second first end of said remaining tape being on a continuation part of the convex outer surface of said second roll of said remaining tape, said tool simultaneously serving as a reusable tab, and said tab indicating the place of said second first end of said remaining tape.
